(19) United States
(12) Patent Application Publication
(10) Pub. No.: US 2026/0057343 A1
(43) Pub. Date: Feb. 26, 2026

(54) ARTIFICIAL INTELLIGENCE AS A SERVICE SYSTEM OF COPPER PROCUREMENT DECISION SUPPORT

(71) Applicants: National Chengchi University, Taipei City (TW); Dinkle Enterprise Co., Ltd, New Taipei City (TW)

(72) Inventors: Rua-Huan TSAIH, Taipei City (TW); Yi-Ling LIN, Taipei City (TW); Yuan-Hsi CHEN, Taipei City (TW); Tsung-Chin CHUANG, Taipei City (TW); Wei-An YANG, Taipei City (TW); Li-Ling TSAO, Taipei City (TW)

(21) Appl. No.: 19/306,362

(22) Filed: Aug. 21, 2025

(30) Foreign Application Priority Data
Aug. 23, 2024 (TW) 113131887

(51) Int. Cl. G06Q 10/087

(52) U.S. Cl. CPC G06Q 10/0872

(57) ABSTRACT

An artificial intelligence as a service (AIaaS) system of copper procurement decision support is provided. The AIaaS system includes a storage device, a processing device, a developer interface, and a user interface. The storage device includes a copper material database and a source code repository, and the processing device executes a plurality of control instructions to access the copper material database and the source code repository, so as to execute a copper material price forecast module, a copper material demand forecast module and a scrap copper price forecast module. The developer interface is used by the developer to establish a copper material price forecast artificial intelligence model, a copper material demand forecast artificial intelligence model, a scrap copper price forecast artificial intelligence model, and the user interface is used by an operator to select and deploy artificial intelligence models to generate a copper material forecast price, a copper material forecast demand and a scrap copper forecast price, and the user interface is used by the decision maker to access forecast results to generate a copper procurement decision support suggestion.

### CROSS-REFERENCE TO RELATED APPLICATION

This application claims the benefit from the Taiwan Patent Application No. 113131887, filed on Aug. 23, 2024, in the Taiwan Intellectual Property Office, the disclosures of which are hereby incorporated by reference in their entirety for all purposes.

### BACKGROUND OF THE INVENTION

### 1. Field of the Invention

The present invention relates to an artificial intelligence as a service (AIaaS) system of copper procurement decision support, and more particularly to an AIaaS with a developer interface and a user interface for performing copper material price forecasting and providing integrated procurement decision support suggestions.

### 2. Description of the Related Art

With the rise of Industry 4.0, the manufacturing industry has shifted from mass production to mass customization, and such transformation requires an integration of existing processes and data in order to establish a new model capable of rapidly responding to market changes, accurately assessing supply and demand, and reducing production costs. Mass customization has increased the complexity of raw material procurement. In recent years, manufacturers have adopted technologies such as the Internet of Things (IoT), cloud computing, artificial intelligence (AI), and machine learning to continuously improve processes and adapt to an ever-changing external environment. However, leveraging artificial intelligence to assist in enterprise transformation is not a trivial task, as it requires significant investment in related hardware and software infrastructure.

Taking manufacturers that utilize copper materials for production and processing as an example, the cost of copper materials accounts for a significant portion of overall production costs. The procurement of copper materials thus has a substantial impact on business operations. By analyzing historical data of raw materials and the prices of related metal materials, it is desirable to employ AI technologies to predict future material prices. Nevertheless, AI technologies often rely on complex algorithms and programming, along with substantial computational resources. These requirements make it difficult for ordinary enterprises and practical operators such as production or procurement personnel to easily adopt and implement such technologies. As a result, there are still significant limitations in actual deployment and operation.

In view of the foregoing, existing copper material price forecasting and integrated procurement decision support remain difficult to implement and utilize effectively. To address these issues, the inventor of the present invention has contemplated and designed an artificial intelligence as a service (AIaaS) system of copper procurement decision support, so as to improve upon the deficiencies of the prior art and enhance practical industrial application.

### SUMMARY OF THE INVENTION

In view of the aforementioned problems in the conventional art, an object of the present invention is to provide an artificial intelligence as a service system of copper procurement decision support, so as to address the difficulty of applying conventional artificial intelligence technologies to frontline production personnel.

According to one aspect of the present invention, an artificial intelligence as a service (AIaaS) system of copper procurement decision support is provided. The AIaaS system includes a storage device, a processing device, a developer interface, and a user interface. The storage device includes a copper material database and a source code repository, and the processing device is connected to the storage device. The processing device is configured to execute a plurality of control instructions to access the copper material database and the source code repository, so as to execute a copper material price forecast module, a copper material demand forecast module and a scrap copper price forecast module. The developer interface is connected to the storage device and the processing device and is applicable to a developer. The developer interface is used by the developer to access the copper material database and the source code repository to establish a copper material price forecast artificial intelligence model in the copper material price forecast module, establish a copper material demand forecast artificial intelligence model in the copper material demand forecast module, establish a scrap copper price forecast artificial intelligence model in the scrap copper price forecast module, and store the copper material price forecast artificial intelligence model, the copper material demand forecast artificial intelligence model, and the scrap copper price forecast artificial intelligence model in the source code repository. The user interface is connected to the storage device and the processing device and is applicable to an operator and a decision maker. The user interface is used by the operator to access the copper material database and the source code repository, select and deploy the copper material price forecast artificial intelligence model, the copper material demand forecast artificial intelligence model and the scrap copper price forecast artificial intelligence model to generate a copper material forecast price, a copper material forecast demand and a scrap copper forecast price, and the user interface is used by the decision maker to access the copper material forecast price, the copper material forecast demand and the scrap copper forecast price to generate a copper procurement decision support suggestion.

Preferably, a developer operation process for establishing the copper material price forecast artificial intelligence model, the copper material demand forecast artificial intelligence model, and the scrap copper price forecast artificial intelligence model includes selecting and establishing input attribute data, training the input attribute data, establishing a learning algorithm of a single-layer neural network, and setting hyperparameters of the artificial intelligence model.

Preferably, the input attribute data of the copper material price forecast artificial intelligence model includes crude oil prices, copper prices of past four weeks, copper prices of past three weeks, copper prices of past two weeks, copper prices of past one week, copper spot prices, gold prices, silver prices, nickel prices, aluminum prices, zinc prices, iron prices, inflation indices, or international exchange rates.

Preferably, the input attribute data of the copper material demand forecast artificial intelligence model includes future two months of a current month, label-encoded material numbers, large-particle material categories, raw material quantities of past four months, raw material quantities of past three months, raw material quantities of past two months, raw material quantities of past one month, estimated raw material usage of the current month or estimated raw material usage of next month.

Preferably, the input attribute data of the scrap copper price forecast artificial intelligence model includes crude oil prices, scrap copper prices of past four weeks, scrap copper prices of past three weeks, scrap copper prices of past two weeks, and scrap copper prices of past one week, copper spot prices, gold prices, silver prices, nickel prices, aluminum prices, zinc prices, iron prices, inflation indices, or international exchange rates.

Preferably, the developer operation process can generate an artificial intelligence model program of the copper material price forecast artificial intelligence model, the copper material demand forecast artificial intelligence model, and the scrap copper price forecast artificial intelligence model, and an accuracy value and a loss value of the artificial intelligence model program.

Preferably, an operator usage process for selecting and deploying the copper material price forecast artificial intelligence model, the copper material demand forecast artificial intelligence model, and the scrap copper price forecast artificial intelligence model includes selecting the artificial intelligence model program from the source code repository, inputting numerical values of the input feature data, and inferring the artificial intelligence model program.

Preferably, the artificial intelligence model program and the input attribute data are stored in a model and data repository.

Preferably, the user interface can include an application program connecting interface connected to the model and data repository, and the application program connecting interface is used by the operator to access the copper material price forecast artificial intelligence model, the copper material demand forecast artificial intelligence model and the scrap copper price forecast artificial intelligence model to obtain the copper material forecast price, the copper material forecast demand and the scrap copper forecast price.

Preferably, the application program connecting interface is provided with a monitoring program, and the monitoring program triggers the artificial intelligence model program for retraining and prediction at a scheduled interval or under a preset condition.

Accordingly, the AIaaS system of the copper procurement decision support according to the present invention can have one or more of the following advantages:
(1) The AIaaS system of the copper procurement decision support is capable of executing the copper material price forecast module, the copper material demand forecast module, and the scrap copper price forecast module and establishing the copper material price forecast artificial intelligence model, the copper material demand forecast artificial intelligence model, and the scrap copper price forecast artificial intelligence model through the modules, respectively, and predicting copper material prices, copper material demands, and scrap copper prices through the AI models, respectively, thereby allowing users to obtain AIaaS system and improve operational efficiency and forecast accuracy.
(2) The AIaaS system of the copper procurement decision support enables the selection and deployment of different versions of the artificial intelligence models for inference. Decision-makers can obtain copper procurement decision support suggestions based on forecast results, and adjust forecast scenarios according to their needs. This flexibility allows accurate procurement decisions through comparison of different forecast results, thereby reducing procurement costs and enhancing production competitiveness.
(3) The AIaaS system of the copper procurement decision support can separate different types of operators based on distinct operating environments, and is suitable for users from various backgrounds, whether or not they possess expertise in artificial intelligence, thereby lowering the cost required to adopt and utilize artificial intelligence and machine learning technologies and enhancing the competitiveness of manufacturers.

### BRIEF DESCRIPTION OF THE DRAWINGS

In order to make the technical features, contents and advantages of the present invention and the effects that can be achieved more obvious, the present invention is described in detail as follows with reference to the accompanying drawings and in the form of an embodiment:

FIG. 1 is a block diagram of an artificial intelligence as a service (AIaaS) system of copper procurement decision support according to one embodiment of the present invention.

FIG. 2 is a schematic diagram of the AIaaS system of the copper procurement decision support according to one embodiment of the present invention.

FIG. 3 is a schematic diagram of a user interface for copper price forecast according to one embodiment of the present invention.

FIG. 4 is a schematic diagram of a user interface for copper procurement demand forecast according to one embodiment of the present invention.

FIG. 5 is a schematic diagram of a user interface for scrap copper price forecast according to one embodiment of the present invention.

FIG. 6 is a schematic diagram of a user interface for decision support suggestion according to one embodiment of the present invention.

### DETAILED DESCRIPTION OF THE PREFERRED EMBODIMENTS

In order to facilitate understanding of the technical features, contents and advantages of the present invention and the effects that can be achieved, the present invention is hereby described in detail as follows with the accompanying drawings and in the form of embodiments. The drawings used therein are only for illustration and auxiliary description, and may not be the true proportions and precise configurations after the implementation of the present invention. Therefore, the proportions and configurations of the attached drawings should not be interpreted to limit the scope of rights of the present invention in actual implementation.

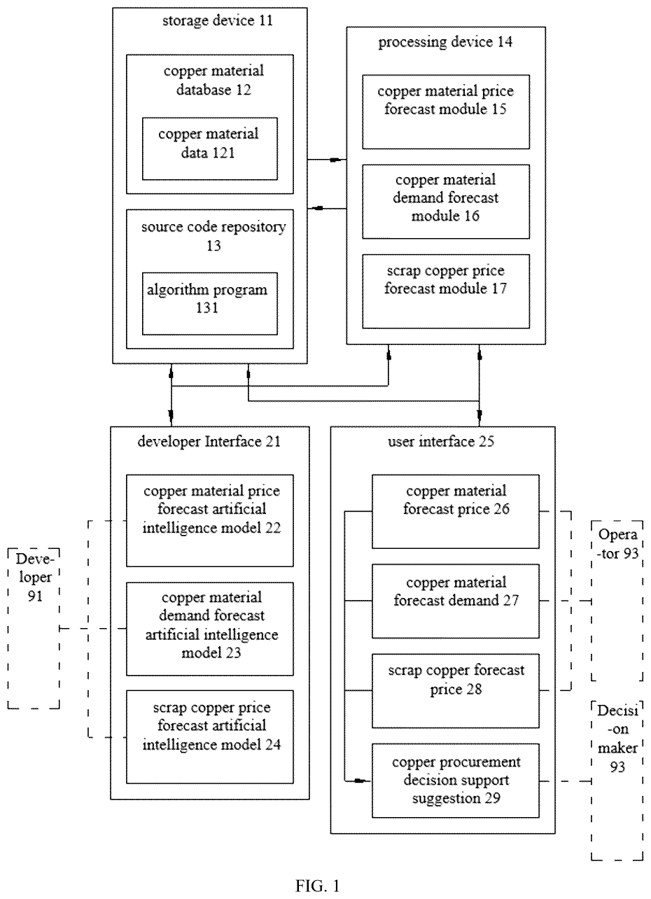

Reference is made to FIG. 1, FIG. 1 is a block diagram of an artificial intelligence as a service (AIaaS) system of copper procurement decision support according to one embodiment of the present invention. As shown in FIG. 1, the AIaaS system 10 of the copper procurement decision support includes a storage device 11, a processing device 14, a developer interface 21 and a user interface 25. The storage device 11 includes a copper material database 12 and a source code repository 13. The storage device 11 can be a storage medium such as a memory, hard disk or disk of a computer device, or a database of a server or cloud device. The copper material database 12 stores various copper material data 121, including historical prices of copper materials, copper material consumption volumes, economic indicators, and other related data. The source code repository 13 stores algorithm programs 131 for performing analytical computations, including various artificial intelligence models and corresponding parameters and variable information. The processing device 14 is connected to the storage device 11. The processing device 14 includes a central processing unit, a microprocessor, or a graphics processing unit in a computer device, or a processor of a server or cloud-based device. The processing device 14 can execute a plurality of control instructions to access the copper material database 12 and the source code repository 13 within the storage device 11, and further execute various computational modules of the AIaaS system 10.

These computational modules include a copper material price forecast module 15, a copper material demand forecast module 16, and a scrap copper price forecast module 17. The copper material price forecast module 15 accesses copper material price data, mineral material prices, macroeconomic indices, exchange rate indices, and other related copper material data 121. After data processing, the algorithm program 131 is used to perform a neural network computation of the artificial intelligence algorithm. Through data training and testing, a copper material price forecast artificial intelligence model is established. Copper material prices are predicted using the artificial intelligence model, such as copper material forecast prices after a designated future time. The copper material demand forecast module 16 accesses copper material consumption data from the copper material data 121. The algorithm program 131 is used to perform neural network computation of the artificial intelligence algorithm. Through data training and testing, a copper material demand forecast artificial intelligence model is established, and the demand quantity is predicted using the artificial intelligence model. The scrap copper price forecast module 17 accesses scrap copper prices, mineral material prices, macroeconomic indices, exchange rate indices, and other related copper material data 121. The algorithm program 131 is used to perform neural network computation of the artificial intelligence algorithm. Through data training and testing, a scrap copper price forecast artificial intelligence model is established, and scrap copper prices are predicted using the artificial intelligence model, such as scrap copper forecast prices after a designated future time. During the manufacturing process, copper processing manufacturers generate scrap copper materials. These scrap copper materials are not directly reusable as copper material raw inputs for production but can be traded to acquire new copper material inputs through resale. However, due to differences in cost and pricing, the copper material prices and the scrap copper prices must be assessed separately. Independent predictions are required so that manufacturers can sell scrap copper when market conditions are favorable, thereby achieving better recovery value and obtaining the most cost-effective raw material costs.

In the aforementioned copper material database 12 and source code repository 13, most of the copper material data 121 in the copper material database 12 comprises data such as dates, prices, and quantities. When proper fields and attributes are defined in the database, general operators can easily access the data without needing programming or coding expertise. In contrast, the algorithm programs 131 in the source code repository 13 involve complex computational formulas, specific programming code, or specially designed parameters. These factors make it difficult for general operators to modify or edit such programs, posing limitations in practical use. Accordingly, the present invention provides two different operating environment interfaces: a developer interface 21 and a user interface 25, enabling different types of users to operate the AIaaS system 10 of the copper procurement decision support within appropriate environments.

The developer interface 21 is connected to the storage device 11 and the processing device 14, and is applicable to a developer 91. The developer 91 accesses the copper material database 12 and the source code repository 13 via the developer interface 21 to establish a copper material price forecast artificial intelligence model 22 in the copper material price forecast module 15, a copper material demand forecast artificial intelligence model 23 in the copper material demand forecast module 16, and a scrap copper price forecast artificial intelligence model 24 in the scrap copper price forecast module 17. In the present embodiment, the developer 91 refers to personnel familiar with artificial intelligence algorithms and corresponding program development. The developer 91 may select or edit applicable algorithm programs through the developer interface 21 to build corresponding artificial intelligence models in the respective forecast modules. The copper material price forecast artificial intelligence model 22, the copper material demand forecast artificial intelligence model 23, and the scrap copper price forecast artificial intelligence model 24 are then stored in the source code repository 13. The developer 91 may test different versions of artificial intelligence models based on different copper material data 121 and algorithm programs 131, and design and build the most suitable artificial intelligence models by comparing the advantages and disadvantages among the models. Version histories of different models may also be stored in the source code repository 13.

The user interface 25 is connected to the storage device 11 and the processing device 14, and is applicable to an operator 92 and a decision-maker 93. Unlike a program operating interface of the developer interface 21, the user interface 25 is primarily a graphical user interface on existing computer or smart devices. The operator 92 or the decision-maker 93 may enter relevant data attributes and set required parameters in table fields within an interface window. The processing device 14 then accesses the storage device 11 to execute the copper material price forecast module 15, the copper material demand forecast module 16, and the scrap copper price forecast module 17 to obtain prediction results. This can be done without modifying computational programs, thereby enhancing ease of use. Specifically, the operator 92 accesses the copper material database 12 and the source code repository 13 via the user interface 25, and selects and deploys the copper material price forecast artificial intelligence model 22, the copper material demand forecast artificial intelligence model 23, and the scrap copper price forecast artificial intelligence model 24 stored in the database, so as to generate the copper material forecast price 26, the copper material forecast demand 27, and the scrap copper forecast price 28. On the other hand, the decision-maker 93 may access the copper material forecast price 26, the copper material forecast demand 27, and the scrap copper forecast price 28 via the user interface 25, and generate a copper procurement decision support suggestion 29 based on the aforementioned information.

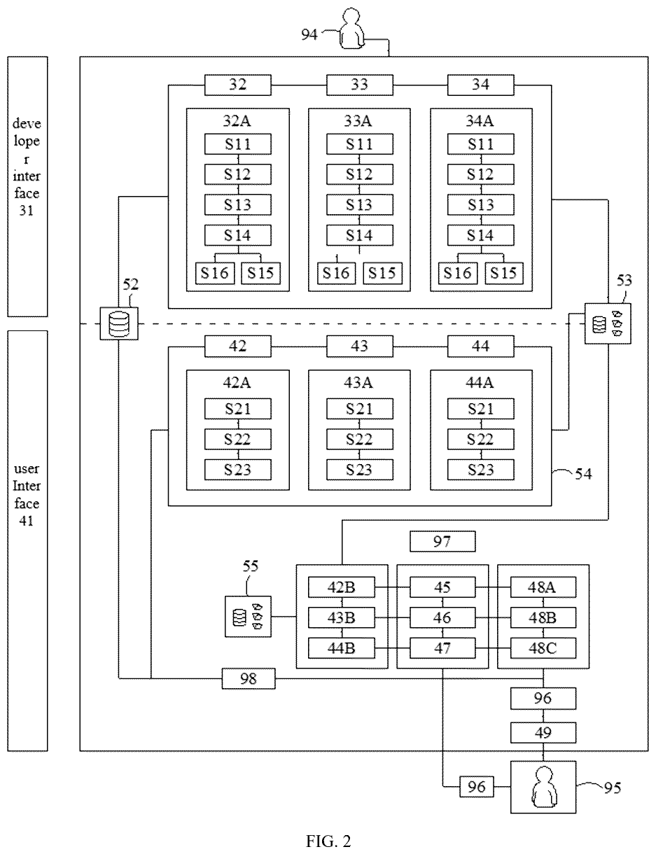

Reference is made to FIG. 2, FIG. 2 is a schematic diagram of the AIaaS system of the copper procurement decision support according to one embodiment of the present invention. As shown in FIG. 2, an AIaaS system 30 of copper procurement decision support is divided into a developer interface 31 and a user interface 41. The developer interface 31 is applicable to a developer 94. The developer 94 edits and executes control program instructions via the developer interface 31 to enable a processing device 51 to access a copper material database 52 and a source code repository 53, and execute a copper material price forecast module 32, a copper material demand forecast module 33, and a scrap copper price forecast module 34. The developer 94 also establishes a copper material price forecast artificial intelligence model 32A, a copper material demand forecast artificial intelligence model 33A, and a scrap copper price forecast artificial intelligence model 34A within the respective modules.

A developer operation process for establishing the copper material price forecast artificial intelligence model 32A, the copper material demand forecast artificial intelligence model 33A, and the scrap copper price forecast artificial intelligence model 34A can include the following steps (S11-S16):

Step S11: selecting and establishing input attribute data. According to the forecast model to be developed, the developer 94 can select and establish different sets of input attribute data. In the copper material price forecast artificial intelligence model 32A, the input attribute data can include crude oil prices, copper prices of past four weeks, copper prices of past three weeks, copper prices of past two weeks, copper prices of past one week, copper spot prices, gold prices, silver prices, nickel prices, aluminum prices, zinc prices, iron prices, inflation indices, or international exchange rates. The data includes historical records stored in the database, metal material prices from various exchanges, and exchange rate data between different currencies. In the copper material demand forecast artificial intelligence model 33A, the input attribute data can include future two months of a current month, label-encoded material numbers, large-particle material categories, raw material quantities of past four months, raw material quantities of past three months, raw material quantities of past two months, raw material quantities of past one month, estimated raw material usage of the current month or estimated raw material usage of next month. In the scrap copper price forecast artificial intelligence model 34A, the input attribute data can include crude oil prices, scrap copper prices of past four weeks, scrap copper prices of past three weeks, scrap copper prices of past two weeks, and scrap copper prices of past one week, copper spot prices, gold prices, silver prices, nickel prices, aluminum prices, zinc prices, iron prices, inflation indices, or international exchange rates.

Step S12: training the input attribute data. The formats, units, and sources of the aforementioned data may vary. A preprocessing operation may be performed to convert the data into a predefined format before being input into the copper material price forecast module 32. The input feature data can further be divided into training data and testing data. These data are input into the algorithm program for training, and the forecast results are obtained through computation.

Step S13: establishing a learning algorithm of a single-layer neural network. In the present embodiment, the artificial intelligence model may be selected as a single-layer neural network model. After training and computation using the data, the forecast results are output. The copper material price forecast artificial intelligence model 32A, the copper material demand forecast artificial intelligence model 33A, and the scrap copper price forecast artificial intelligence model 34A are respectively established.

Step S14: setting hyperparameters of the artificial intelligence models. The forecast results of each artificial intelligence model are evaluated, and the parameter values within the models are adjusted accordingly.

Step S15: generating an artificial intelligence model program. The copper material price forecast artificial intelligence model 32A, the copper material demand forecast artificial intelligence model 33A, and the scrap copper price forecast artificial intelligence model 34A, after parameter tuning, can be treated as a version of the forecast model developed by the developer 94. This version can be stored in the source code repository 53 for use by other users.

Step S16: generating an accuracy value and a loss value of the artificial intelligence model program. For the corresponding development version of the artificial intelligence model, the accuracy value and loss value of each artificial intelligence model program may be calculated, serving as the basis for evaluating the performance of the model's prediction.

On the other hand, the user interface 41 is adapted for a user 95, who may be either an operator or a decision-maker of the system. The user 95 selects or inputs corresponding control program instructions via the user interface 41, thereby enabling the processing device 54 to access the copper material database 52 and the source code repository 53, and execute a copper material price forecast module 42, a copper material demand forecast module 43, and a scrap copper price forecast module 44. The user 95 is not required to select algorithms or edit code, but instead selects and deploys the previously stored copper material price forecast artificial intelligence model 42A, the copper material demand forecast artificial intelligence model 43A, and the scrap copper price forecast artificial intelligence model 44A from the source code repository 53 to perform prediction analysis.

An operator usage process for selecting and deploying the copper material price forecast artificial intelligence model 42A, the copper material demand forecast artificial intelligence model 43A, and the scrap copper price forecast artificial intelligence model 44A can include the following steps (S21-S23):

Step S21: selecting the artificial intelligence model program from the source code repository. The user 95 can identify a version of the artificial intelligence model stored in the source code repository 53 that matches forecast requirements and use it as the deployed forecast model.

Step S22: inputting numerical values of the input attribute data. After selecting the forecast model, the user inputs the corresponding values of the input attribute data according to the type of forecast to be performed. The input attribute data can refer to those described in step S11, and the details are not repeated herein.

Step S23: performing inference using the artificial intelligence model program. After the input data is provided, each of the forecast modules performs inference using the copper material price forecast artificial intelligence model 42A, the copper material demand forecast artificial intelligence model 43A, and the scrap copper price forecast artificial intelligence model 44A, respectively. The results of the inference operations can be stored in a model and data repository 55.

The user 95 can use a user device 96, such as a handheld device, a mobile device, or a smart computing device, to perform the aforementioned selection and deployment of the artificial intelligence models. Operations are performed through an application programming interface 97, which accesses the copper material price forecast artificial intelligence model 42B, the copper material demand forecast artificial intelligence model 43B, and the scrap copper price forecast artificial intelligence model 44B stored in the model and data repository 55, thereby obtaining a copper material forecast price 45, a copper material forecast demand 46, and a scrap copper forecast price 47.

After obtaining the forecast results from each module, the user 95 may further perform analysis through the artificial intelligence as a service of copper procurement decision support. The copper material forecast price 45, the copper material forecast demand 46, and the scrap copper forecast price 47 can be accessed via a copper material price forecast service 48A, a copper material demand forecast service 48B, and a scrap copper price forecast service 48C, respectively, and used to generate a copper procurement decision support suggestion 49 based on the aforementioned information. The copper procurement decision support suggestion 49 may be presented on a display screen of the user device 96, or alternatively, transmitted as a message or email to the user device 96, enabling the user 95 to make informed copper procurement decisions based on the provided suggestions. The application programming interface 97 can be equipped with a monitoring program 98. The monitoring program 98 can trigger the artificial intelligence model program to perform retraining and prediction at scheduled intervals or under predetermined conditions. For example, the copper material database 52 can be updated monthly, and the monitoring program can automatically initiate training computation and store the updated results in the source code repository 53 or the model and data repository 55.

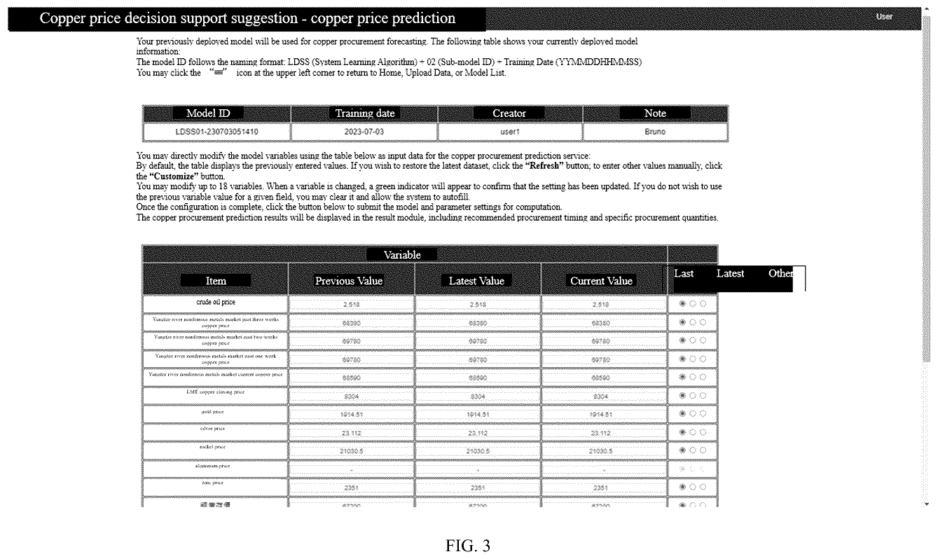

Reference is made to FIG. 3, FIG. 3 is a schematic diagram of a user interface for copper price forecast according to one embodiment of the present invention. As shown in FIG. 3, the user can perform a copper price forecast operation via the user device as illustrated. Through the user interface, a deployed model can be selected. Each model includes corresponding information such as training date, creator, version, and descriptive comments. Upon selecting a corresponding model, the user can adjust the variable values in the variable input fields, such as prices of raw materials, copper, and metal materials. These values can be input based on previous data, the latest available data, or user-defined data. After the variables are determined, the copper material price forecast artificial intelligence model can be executed to predict the copper price after a specified period, thereby completing the copper price forecast operation.

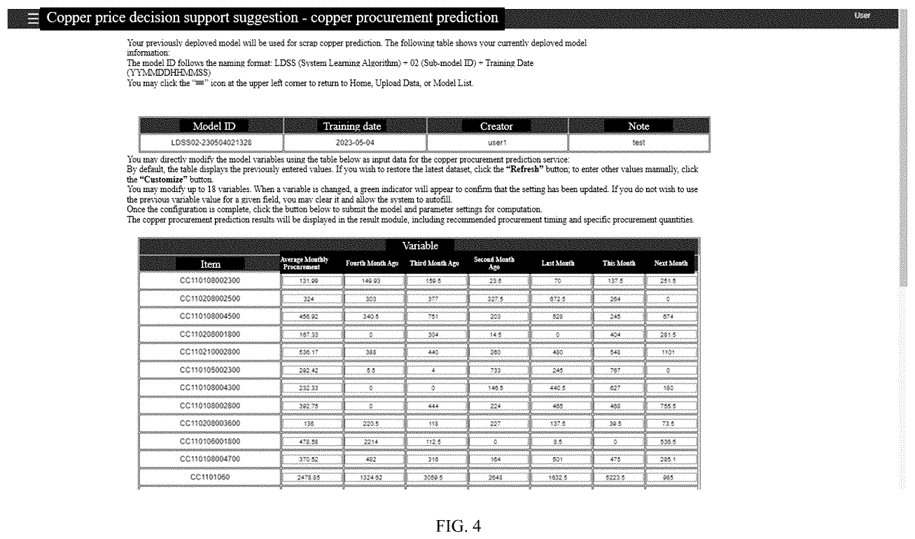

Reference is made to FIG. 4, FIG. 4 is a schematic diagram of a user interface for copper procurement demand forecast according to one embodiment of the present invention. As shown in FIG. 4, the user can perform a copper procurement demand forecast operation via the user device as illustrated. Through the user interface, a deployed model can be selected. Each model includes corresponding training date, creator, version, and descriptive comments. Upon selecting a corresponding model, the user can adjust the variable values in the input fields, such as monthly procurement quantities for corresponding raw materials. These values can be input based on historical data, the latest available data, or custom input. After determining the input variables, the copper material demand forecast artificial intelligence model can be executed to predict the procurement demand after a specified period, thereby completing the copper procurement demand forecast operation.

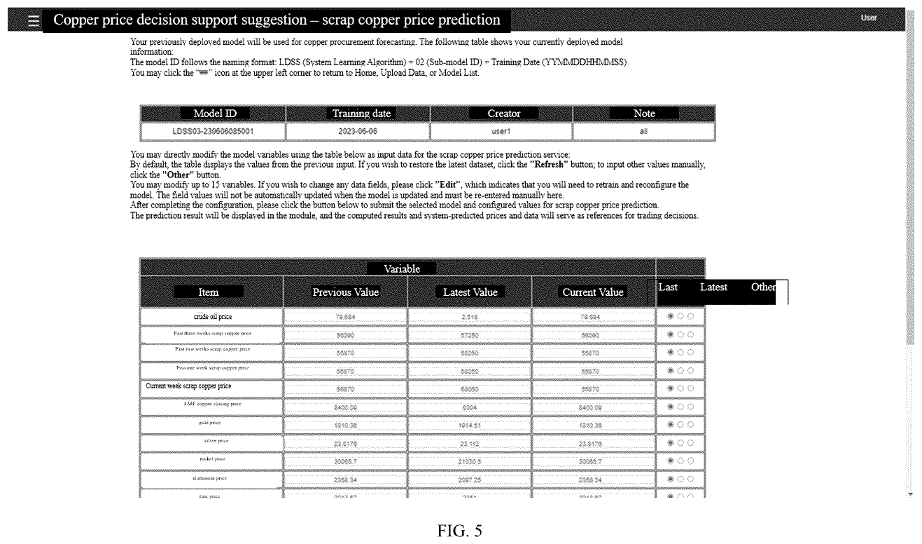

Reference is made to FIG. 5, FIG. 5 is a schematic diagram of a user interface for scrap copper price forecast according to one embodiment of the present invention. As shown in FIG. 5, the user can perform a scrap copper price forecast operation via the user device as illustrated. Through the user interface, a deployed model can be selected. Each model includes corresponding information such as training date, creator, version, and descriptive comments. Upon selecting a corresponding model, the user can adjust the variable values in the variable input fields, such as prices of raw materials, scrap copper, copper materials, and metal materials. These values can be input based on previous data, the latest available data, or user-defined data. After the variables are determined, the scrap copper price forecast artificial intelligence model can be executed to predict the scrap copper price after a specified period, thereby completing the copper price forecast operation.

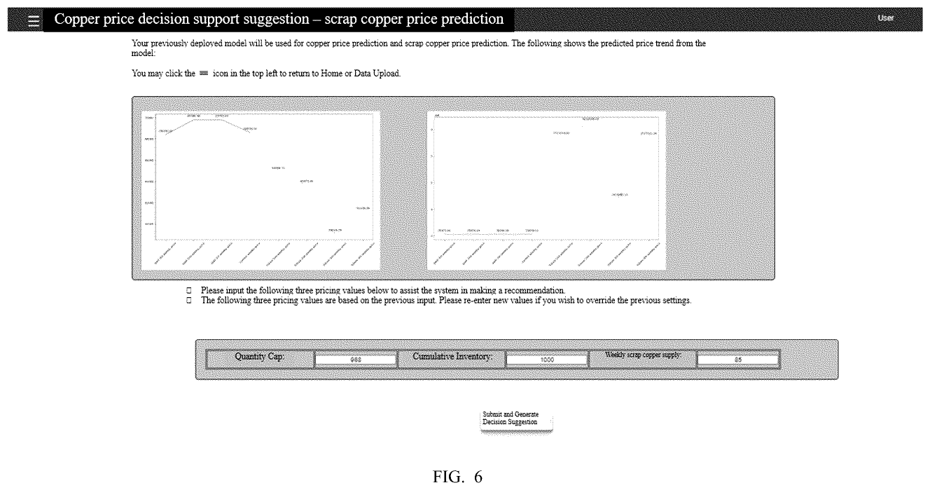

Reference is made to FIG. 6, FIG. 6 is a schematic diagram of a user interface for decision support suggestion according to one embodiment of the present invention. As shown in FIG. 6, after completing operations using the copper material price forecast artificial intelligence model, the copper material demand forecast artificial intelligence model, and the scrap copper price forecast artificial intelligence model, the user can further initiate a copper procurement decision support suggestion through the copper material price forecast service. In particular, the copper material price forecast artificial intelligence model predicts copper prices for one to four weeks into the future, and the scrap copper price forecast artificial intelligence model predicts scrap copper prices for the same future period. By additionally considering the copper material forecast demand quantity, the system provides a copper procurement decision support suggestion. The suggestion includes the recommended procurement quantity of copper materials and the suggested exchange quantity of scrap copper. The decision-maker can follow the suggestion to instruct procurement and materials management personnel to generate orders, ensuring that the required copper materials are acquired within the designated period.

The above description is provided for illustrative purposes only and should not be construed as limiting. Any modifications or equivalent changes that do not depart from the spirit and scope of the present invention shall fall within the scope of the following claims.

What is claimed is:

1. An artificial intelligence as a service (AIaaS) system of copper procurement decision support, the AIaaS system comprising:
a storage device comprising a copper material database and a source code repository;
a processing device connected to the storage device, wherein the processing device is configured to execute a plurality of control instructions to access the copper material database and the source code repository, so as to execute a copper material price forecast module, a copper material demand forecast module and a scrap copper price forecast module;
a developer interface connected to the storage device and the processing device, the developer interface being applicable to a developer, wherein the developer interface is used by the developer to access the copper material database and the source code repository to establish a copper material price forecast artificial intelligence model in the copper material price forecast module, establish a copper material demand forecast artificial intelligence model in the copper material demand forecast module, establish a scrap copper price forecast artificial intelligence model in the scrap copper price forecast module, and store the copper material price forecast artificial intelligence model, the copper material demand forecast artificial intelligence model, and the scrap copper price forecast artificial intelligence model in the source code repository; and
a user interface connected to the storage device and the processing device, the user interface being applicable to an operator and a decision maker, wherein the user interface is used by the operator to access the copper material database and the source code repository, select and deploy the copper material price forecast artificial intelligence model, the copper material demand forecast artificial intelligence model and the scrap copper price forecast artificial intelligence model to generate a copper material forecast price, a copper material forecast demand and a scrap copper forecast price, and the user interface is used by the decision maker to access the copper material forecast price, the copper material forecast demand and the scrap copper forecast price to generate a copper procurement decision support suggestion.

2. The AIaaS system of the copper procurement decision support according to claim 1, wherein a developer operation process for establishing the copper material price forecast artificial intelligence model, the copper material demand forecast artificial intelligence model, and the scrap copper price forecast artificial intelligence model comprises selecting and establishing input attribute data, training the input attribute data, establishing a learning algorithm of a single-layer neural network, and setting hyperparameters of the artificial intelligence model.

3. The AIaaS system of the copper procurement decision support according to claim 2, wherein the input attribute data of the copper material price forecast artificial intelligence model comprises crude oil prices, copper prices of past four weeks, copper prices of past three weeks, copper prices of past two weeks, copper prices of past one week, copper spot prices, gold prices, silver prices, nickel prices, aluminum prices, zinc prices, iron prices, inflation indices, or international exchange rates.

4. The AIaaS system of the copper procurement decision support according to claim 2, wherein the input attribute data of the copper material demand forecast artificial intelligence model comprises future two months of a current month, label-encoded material numbers, large-particle material categories, raw material quantities of past four months, raw material quantities of past three months, raw material quantities of past two months, raw material quantities of past one month, estimated raw material usage of the current month or estimated raw material usage of next month.

5. The AIaaS system of the copper procurement decision support according to claim 2, wherein the input attribute data of the scrap copper price forecast artificial intelligence model comprises crude oil prices, scrap copper prices of past four weeks, scrap copper prices of past three weeks, scrap copper prices of past two weeks, and scrap copper prices of past one week, copper spot prices, gold prices, silver prices, nickel prices, aluminum prices, zinc prices, iron prices, inflation indices, or international exchange rates.

6. The AIaaS system of the copper procurement decision support according to claim 2, wherein the developer operation process generates an artificial intelligence model program of the copper material price forecast artificial intelligence model, the copper material demand forecast artificial intelligence model, and the scrap copper price forecast artificial intelligence model, and an accuracy value and a loss value of the artificial intelligence model program.

7. The AIaaS system of the copper procurement decision support according to claim 6, wherein an operator usage process for selecting and deploying the copper material price forecast artificial intelligence model, the copper material demand forecast artificial intelligence model, and the scrap copper price forecast artificial intelligence model comprise selecting the artificial intelligence model program from the source code repository, inputting numerical values of the input feature data, and inferring the artificial intelligence model program.

8. The AIaaS system of the copper procurement decision support according to claim 7, wherein the artificial intelligence model program and the input attribute data are stored in a model and data repository.

9. The AIaaS system of the copper procurement decision support according to claim 8, wherein the user interface comprises an application program connecting interface connected to the model and data repository, and the application program connecting interface is used by the operator to access the copper material price forecast artificial intelligence model, the copper material demand forecast artificial intelligence model and the scrap copper price forecast artificial intelligence model to obtain the copper material forecast price, the copper material forecast demand and the scrap copper forecast price.

10. The AIaaS system of the copper procurement decision support according to claim 9, wherein the application program connecting interface is provided with a monitoring program, and the monitoring program triggers the artificial intelligence model program for retraining and prediction at a scheduled interval or under a preset condition.
